(19) United States
(12) Patent Application Publication
(10) Pub. No.: US 2003/0187908 A1
(43) Pub. Date: Oct. 2, 2003

(54) Methods and systems for customer based resource priority control

(75) Inventor: Michael L. Boucher, Lafayette, CO (US)

Correspondence Address: John F. Nethery, SONNENSCHEIN NATH & ROSENTHAL, Wacker Drive Station, Sears Tower, P.O. Box #061080, Chicago, IL, 60606-1080, US

(73) Assignee: SUN MICROSYSTEMS, INC.

(21) Appl. No.: 10/106,791

(22) Filed: Mar. 26, 2002

(51) Int. Cl. G06F 9/00; G06F 15/163; G06F 9/54

(52) U.S. Cl. 709/103

(57) ABSTRACT

Methods, systems, and articles of manufacture consistent with the present invention provide customer based resource priority control. The method includes identifying a customer for which a task will be performed by a program, obtaining a customer tag representing the customer, and submitting the customer tag to a priority control program to inform the data processing system that the program is working for the customer. The method also includes identifying a customer level of service based on the customer tag, adjusting a resource priority based on the customer level of service, and running the program in accordance with the resource priority and the customer level of service.

### FIELD OF THE INVENTION

This invention relates to the field of computer operating systems. In particular, this invention relates to resource priority control for processes and threads executing tasks on behalf of customers assigned a particular level of service.

### BACKGROUND OF THE INVENTION

An operating system schedules processes or threads using priorities that are attached to each thread. Threads with high priority usually have preferential access to resources over threads with lower priority. The thread priority may indicate, for example, how frequently the CPU processes thread instructions. In the past, the priority for a thread was typically a function of the process with which the thread was associated.

The software architecture in modern computer systems tends to include a single instance of a server-level program that executes tasks with a range of priorities. For example, a database program may respond to queries from thousands of customers, where each query may have a different importance (and therefore, ideally, a different priority). However, server programs typically have an unsatisfactorily small range of options for responding to the multiple customers.

One option is to establish a single database server and give all customers the same priority. Another option is to create multiple servers each having a different priority, and assign customer queries to each server according to the priority of the query. However, these two options, although inflexible, are the options used in existing eCommerce computer systems.

Therefore, a need has long existed for resource priority control that overcomes the problems noted above and others previously experienced.

### SUMMARY OF THE INVENTION

Methods and systems consistent with the present invention provide flexible resource priority control suitable, for example, for eCommerce systems. These methods and systems facilitate resource priority control tailored to individual customers as a unit of work performed for the customer uses one or more resources (e.g., CPU time, disk I/O, threads, processes, and the like) during the lifetime of the unit of work. As an example, a unit of work may be a database search for a book. During the lifetime of the unit of work, the search may require CPU, disk, and I/O resources to find the book in a database, retrieve a description record for the book, and transmit the record to the customer.

According to one aspect of the present invention, such methods and systems, as embodied and broadly described herein, include a priority control program that sets resource priority levels responsive to thread communications regarding the current customer being serviced. As will be explained in detail below, the customer based resource priority scheduling helps to insure that customers receive the level of service that they have paid for, have earned, or have been granted regardless of which resources are used to process a unit of work for the customer at any given time. The resource priority control techniques set forth below also provide observability on a customer level. In other words, the data processing systems are able to track and record the use of system resources on a per-customer basis, and thus provide related accounting, billing, and analysis functionality.

Methods and systems consistent with the present invention overcome the shortcomings of the related art, for example, by providing a priority control program that is responsive to thread communications that indicate the customer for which the thread is currently working. The thread communication generally includes a customer tag identifying a specific customer or class of customer. The priority control program thereby allows a data processing system to establish priorities for all of the tasks and resources used during system interaction with a particular customer or class of customer, rather than coarsely setting priority globally for all customers on a per-process (as opposed to per-customer) basis. Thus, a data processing system may readily provide a level of service appropriate to the customers as individuals.

In accordance with methods consistent with the present invention, a method is provided for customer resource priority control. The method includes identifying a customer for which a task will be performed by a program, obtaining a customer tag representing the customer, and submitting the customer tag to a priority control program to inform the data processing system that the program is working for the customer. The method also includes identifying a customer level of service based on the customer tag, adjusting a resource priority based on the customer level of service, and performing the task.

In accordance with systems consistent with the present invention, a data processing system is provided for providing resource priority control. The data processing system includes a memory comprising a priority control program (running, for example, as part of an operating system) and a task-resource priority table. The priority control program receives a customer tag submitted by an application program (or a thread) performing work on behalf of a customer, obtains a customer level of service assigned to the customer, and responsively adjusts a resource priority in accordance with the task-resource table. The data processing system further includes a processor that runs the priority control program.

In accordance with articles of manufacture consistent with the present invention, a computer-readable medium is provided. The computer-readable medium contains instructions that cause a data processing system to perform a method for resource priority control. The method includes identifying a customer for which a task will be performed by a program, obtaining a customer tag representing the customer, and submitting the customer tag to a priority control program to inform the data process system that the program is working for the customer. The method also includes identifying a customer level of service based on the customer tag, and adjusting a resource priority based on the customer level of service.

Other apparatus, methods, features and advantages of the present invention will be or will become apparent to one with skill in the art upon examination of the following figures and detailed description. It is intended that all such additional systems, methods, features and advantages be included within this description, be within the scope of the present invention, and be protected by the accompanying drawings.

### BRIEF DESCRIPTION OF THE DRAWINGS

FIG. 1 depicts a block diagram of a data processing system suitable for practicing methods and implementing systems consistent with the present invention.

FIG. 2 depicts a customer tag that provides programs running in the data processing system shown in FIG. 1 with a mechanism for identifying customers.

FIG. 3 depicts a customer level of service table that the operating system in the data processing system in FIG. 1 may use to ascertain a customer level of service appropriate for a customer.

FIG. 4 depicts two task-resource priority tables that the operating system in the data processing system in FIG. 1 may use to ascertain resource priorities for a given customer level of service.

FIG. 5 depicts a flow diagram of the steps that a thread or process running in the data processing system of FIG. 1 may take to identify customers and inform the operating system that the thread or process is working for the customer.

FIG. 6 depicts a flow diagram of the steps that the operating system running in the data processing system shown in FIG. 1 may take when processing a customer identification message from a thread in order to set appropriate resource priorities for the customer.

FIG. 7 depicts a flow diagram of the steps that the operating system running in the data processing system shown in FIG. 1 may take in order to determine when to track customer resource usage.

### DETAILED DESCRIPTION OF THE INVENTION

Reference will now be made in detail to an implementation in accordance with methods, systems, and products consistent with the present invention as illustrated in the accompanying drawings. The same reference numbers may be used throughout the drawings and the following description to refer to the same or like parts. Note also that although the discussion below proceeds with reference to an online book selling service, that the customer based resource priority control described may be applied to any data processing system.

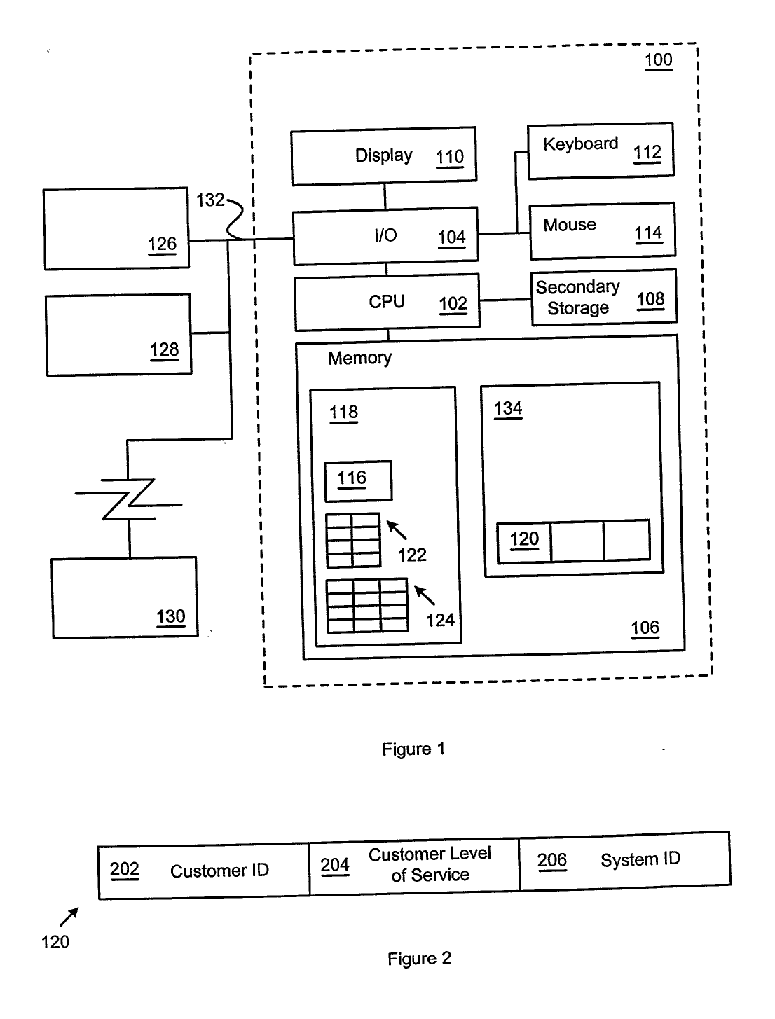

FIG. 1 depicts a block diagram of a data processing system 100 suitable for practicing methods and implementing systems consistent with the present invention. The data processing system 100 comprises a central processing unit (CPU) 102, an input output I/O unit 104, a memory 106, a secondary storage device 108, and a video display 110. The data processing system 100 may further include standard input devices such as a keyboard 112, a mouse 114 or a speech processing means (not illustrated).

The memory 106 contains a priority control program 116 that may be part of an operating system program 118, for example. The memory further contains customer tags 120, customer level of service tables 122, and task-resource priority tables 124 (each described in more detail below). As shown, the customer tag 120 is attributed to a thread 134 which is performing work on behalf of a customer, while the customer level of service table 122 and task-resource priority table 124 are attributed to the operating system 118. Other arrangements are also suitable, however. Customers that operate the remote terminals 126, 128, and 130 communicate with the data processing system 100 using hardwired or wireless LAN or WAN network links 132, including the Internet. As an example, the data processing system 100 may be an online book selling data processing system. The remote terminals 126-130 may then represent personal computers that connect to the data processing system 100 from home over the Internet through a web browser.

In many instances, customers will be human beings. For example, the customer may be a person interested in purchasing books from home. However, customers may also be a hardware or software entity. For example, a customer may be a program or thread running on data processing systems locally or in a distributed manner. In other words, the customer programs may, in a manner similar to human customers, request and consume resources that they need in order to accomplish their tasks.

Although aspects of the present invention are depicted as being stored in memory 106, one skilled in the art will appreciate that all or part of systems and methods consistent with the present invention may be stored on or read from other computer-readable media. For example, the storage may include secondary storage devices such as hard disks, floppy disks, and CD-ROMs; a signal received from a network such as the Internet; or other forms of ROM or RAM either currently known or later developed. Further, although specific components of data processing system 100 are described, one skilled in the art will appreciate that a data processing system suitable for use with methods, systems, and articles of manufacture consistent with the present invention may contain additional or different components.

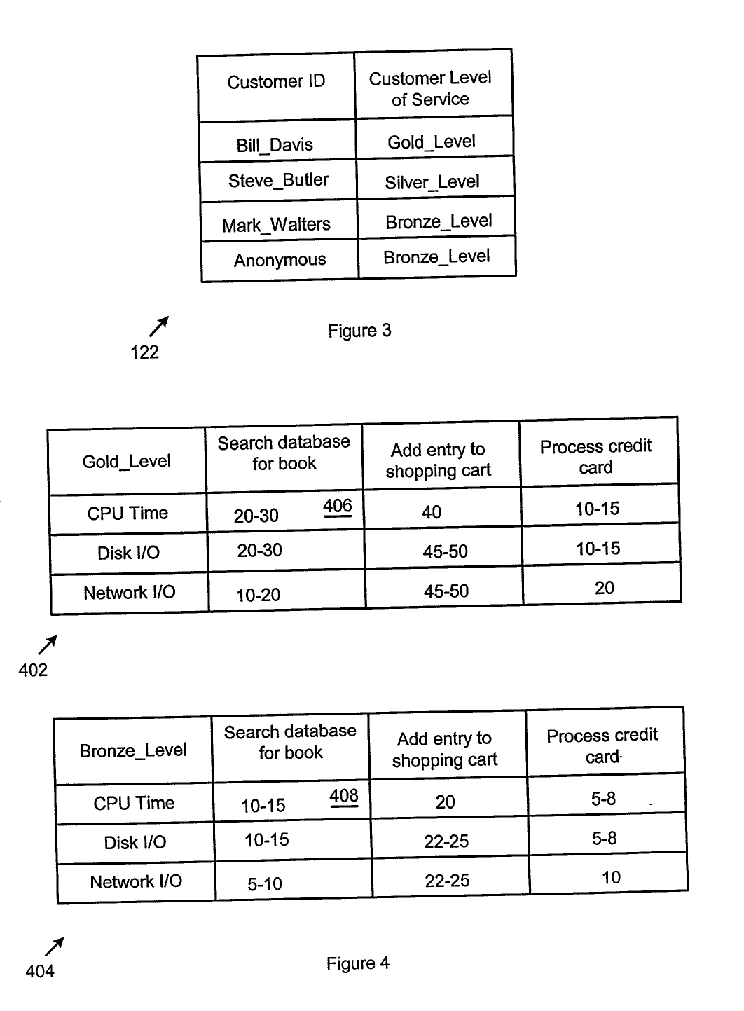

Before discussing in detail the processing flow for resource priority control, several data structures will be introduced. Turning first to FIG. 2, that figure shows a customer tag 120. The customer tag 120 includes a customer identification field 202, a customer level of service field 204, and a system identification field 206.

The customer identification field 202 provides an identifier of a customer on behalf of which a thread or process is doing or will be doing a task or a unit of work. To that end, the customer identifier may be a bit sequence specifically assigned to a customer. The customer identifier may be obtained, for example, after a customer enters a user name and password, or other identifying indicia. A temporary anonymous customer identifier may also be obtained in order to provide the programs running in the data processing system 100 in FIG. 1 with an identifier for tracking work performed on behalf of a customer who has not yet identified himself.

In one implementation, a Java UID-Generator interface may be used to return a unique bit sequence for the customer identifier. The UID-Generator produces an object identifier that is unique with respect to the host on which it is generated. The programs running in the data processing system 100 shown in FIG. 1 may then use the unique object identifiers as customer identifiers. Optionally, the programs may use a globally unique identifier formed by pairing the object identifier with, for example, an internet address (e.g., an IP or Ethernet address). For example, the following pseudocode constructs a globally unique object identifier:

import java.net.InetAddress;

import java.net.UnknownHostException;

import java.rmi.server.UID;

public class UIDProgram {

public static void main(String□ args) {

try {

UID uniqueHostId = new UID( );
System.out.printIn(“uniqueHostId = ” +

uniqueHostId.toString( ));

InetAddress.myInetAddress = InetAddress.getLocalHost( );
System.out.printIn(“myInetAddress = “ +

myInetAddress.to.String( ));

System.out.printIn(“Global UID = ”+

myInetAddress.toString( ) + uniqueHostId.toString( ));

}
catch (UnknownHostException e) {

System.out. printIn(“Caught Unknown HostException”);

}

}

}

Note also that pairing the unique customer identifier with a data processing system identifier provides a customer tag that is unique across different data processing systems. The data processing system identifier may be, as examples, a network address (e.g., an Internet Protocol (IP) address, or an Ethernet address). As will be explained in more detail below, the resultant customer tag may then be used to track customer resource usage across multiple data processing systems.

The operating system 118 may use anonymous customer identifications when the data processing system 100 begins work for a customer who has not yet identified himself. In that scenario, as noted above, the data processing system may assign a temporary anonymous customer identifier to the customer. The temporary anonymous customer identifiers may be distinguished, for example, using a predetermined bit pattern present in the customer identifier. When a program or thread running in the data processing system 100 later learns the identity of the customer, the thread or program informs the operating system 118 of the customer identity, and the operating system 118 then replaces the temporary anonymous customer identifier with a non-anonymous identifier for that customer. In addition, the operating system 118 may then update any resource tracking logs initially created to track resource usage by the anonymous customer in order to reflect that the work was in fact done for the now-identified customer. The customer level of service field 204 provides an entry in the customer tag 120 to store an indicator of a level of service that the customer has paid for, has earned, or has otherwise been assigned. Although a thread may not initially know what level of service to attribute to a customer, the thread may receive the appropriate level of service in a message from the priority control program 116. The thread may then insert the customer level of service into the customer tag 120 for future communications with the operating system. As a result, the thread may save the operating system the time and resource usage associated with looking up the appropriate customer level of service (e.g., based on the customer identifier) in each instance that the thread informs the operating system that the thread is working for the customer.

The system identification field 206 stores an indicator of the data processing system on which a thread doing work for a customer is executing. In providing a system identifier, the system identification field 206 may store an identifier string, a network address, or the like. As examples, the network address may be an IP address or Ethernet address.

Thus, even when customer tasks are handed across multiple data processing systems, the priority control program 116 may construct a complete record of resource usage. To that end, when a task is handed from an originating machine to a destination machine for the customer, the customer tag 112 is updated with the system identification of the originating machine. The destination machine may then inquire about the customer resource usage from the originating machine, and continue to build the resource usage log. Similarly, the destination machine may pass a task for the customer to yet another machine, which may then continue to construct the resource usage log as noted above.

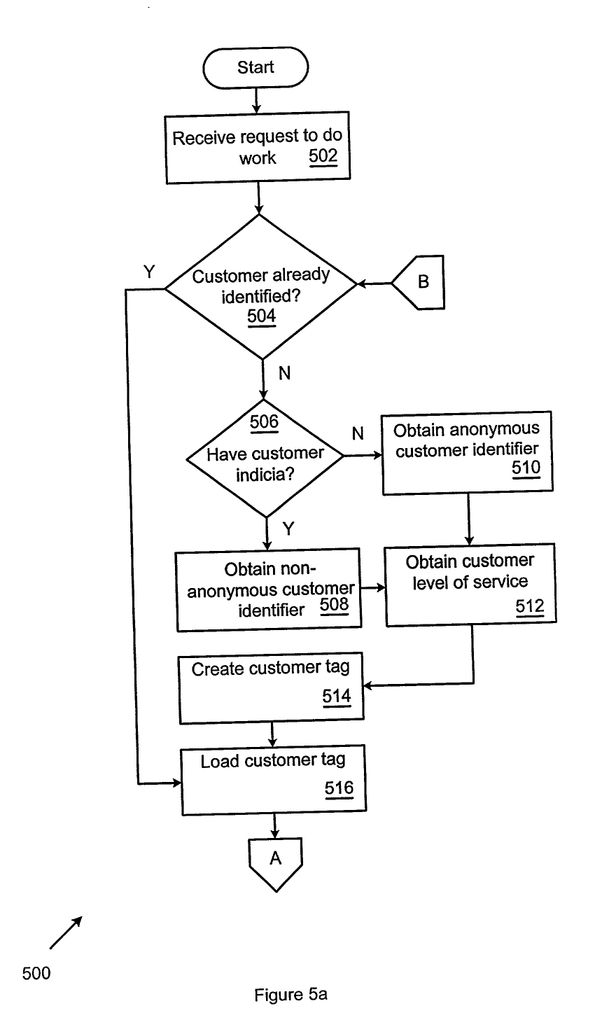

With regard next to FIG. 3, that figure shows one example of a customer level of service table 122. The customer level of service table provides a customer level of service entry for each customer known to the data processing system. The customer level of service table 122 grows as the operating system identifies new customers and adds them to the table 122.

As shown in FIG. 3 there are four customer identifications: Bill_Davis, Steve_Butler, Mark_Walters, and Anonymous. Bill_Davis receives Gold_Level level of service, Steve_Butler receives Silver_Level level of service, and Mark_Walters receives Bronze_Level level of service. Note also that a customer level of service (in this case Bronze_Level) is granted to Anonymous customers.

The customer levels of service determine the priorities at which system resources are available to a customer. The customer level of service may be determined in many ways. As examples, the customer may pay for a certain customer level of service, the customer may earn the level of service (e.g., by purchasing predetermined amounts of goods), or the customer may be assigned a level of service for promotional or other reasons.

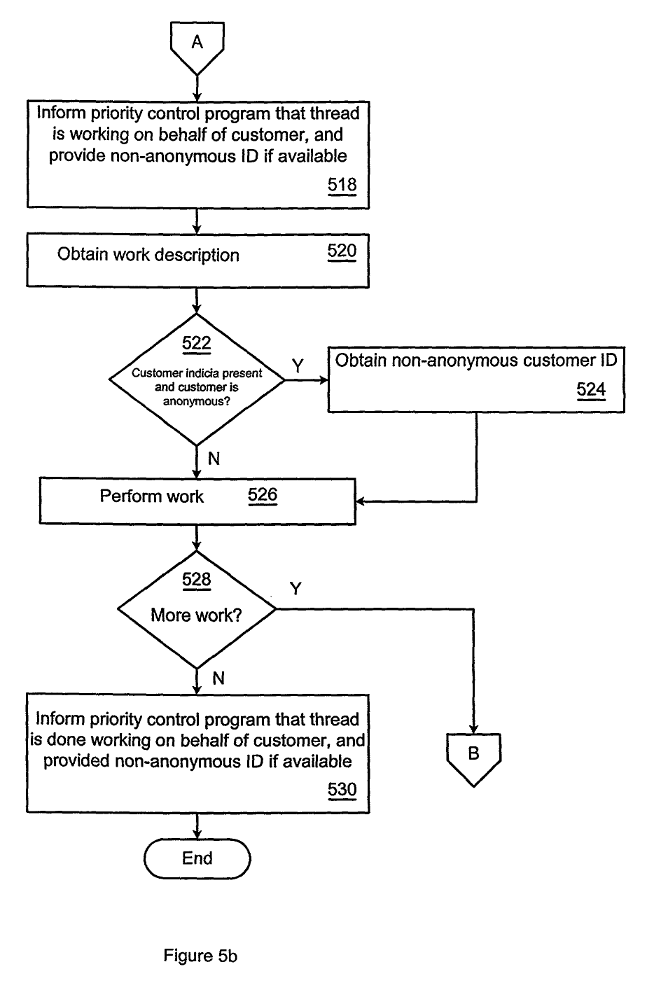

With reference next to FIG. 4, the task-priority tables 402 and 404 show examples of mapping Gold_Level and Bronze_Level levels of service to resource priorities. The task-priority tables 402 and 404 include a resource index that specifies systems resources including (as examples) CPU time, Disk I/O, and Network I/O, as well as a task index that specifies tasks including searching a database, adding selections to a shopping cart, and processing a credit card. The task-priority tables 402 and 404 may be expanded by adding additional tasks and resources, or additional indices such as time of day, and the like. A CPU time-data base search task priority pair is identified as element 406 in the task-priority table 402 and as element 408 in the task-priority table 404.

As shown in the task-priority table 402, Gold_Level customers have a priority between 20 and 30 for CPU time spent on the task of searching a database for a book. In contrast, Bronze_Level customers have a priority between 10-15 for the same task-priority pair.

Note that the priority may be specified as a range (e.g., 10-15), or as a single number (e.g., 10). Specifying a range permits the data processing system 100 to age the priority over time. As an example, while a Gold_Level customer may initially start at the high end of the priority range (i.e., 30) for CPU time spent searching a data base, over time the data processing system may decrease the priority toward the low end of the range (i.e., 20). Aging helps to ensure that other customers also receive adequate response from the data processing system, rather than allowing a single thread to run for extended periods of time at a very high priority.

Note that in one implementation, as shown in FIG. 1, the operating system 118 includes a priority control program 116 and maintains the customer level of service table 122 and the task-resource priority table 124. Thus, for example, the operating system 118 adds to the customer level of service table 122 by inserting additional customer identifiers and associated levels of service. The operating system 118 also adds, removes, and modifies entries in the task-resource priority table 124 in order to reflect the present implementation of customer priorities.

With regard to the task-resource priorities in the task-resource priority table 124, the operating system 118 applies the resource priorities during operation of the data processing system 100 and execution of the programs and threads running in the data processing system 100. As an example, a given priority level for CPU time affects the manner in which the operating system 118 schedules thread and program instructions for execution. In particular, higher CPU time priority levels may result in the operating system 118 scheduling more instructions for a particular thread or program over a certain period of time. Thus, higher priority programs accomplish tasks in less time and achieve the level of service that has been attributed to the customer for which the program is working.

Note that interprocess communication techniques may be used to pass priority related messages between the operating system 118, priority control program 116, and threads and processes running on behalf of customers. Thus, for example, a thread may send a message including a customer tag to the priority control program 116 to inform the priority control program 116 that the thread is performing work on behalf of a particular customer. The priority control program 116 may then retrieve the customer level of service for the customer from the customer level of service table 122, retrieve the resource priority levels from the resource table 124, and send a message to the operating system 118 to set the priority levels so that resource usage scheduled by the operating system 118 occurs in accordance with the customer level of service. Other communication techniques are also suitable, however, including, for example, using shared memory.

Note that the priority control allows the data processing system 100 to establish a customer level of service in the data processing system 100 that applies to each unit of work performed for the customer. Furthermore, as the unit of work is handed across multiple threads or processes (some of which may in fact execute on different data processing systems) during the lifetime of the unit of work, those threads and processes operate under the customer level of service appropriate for the customer.

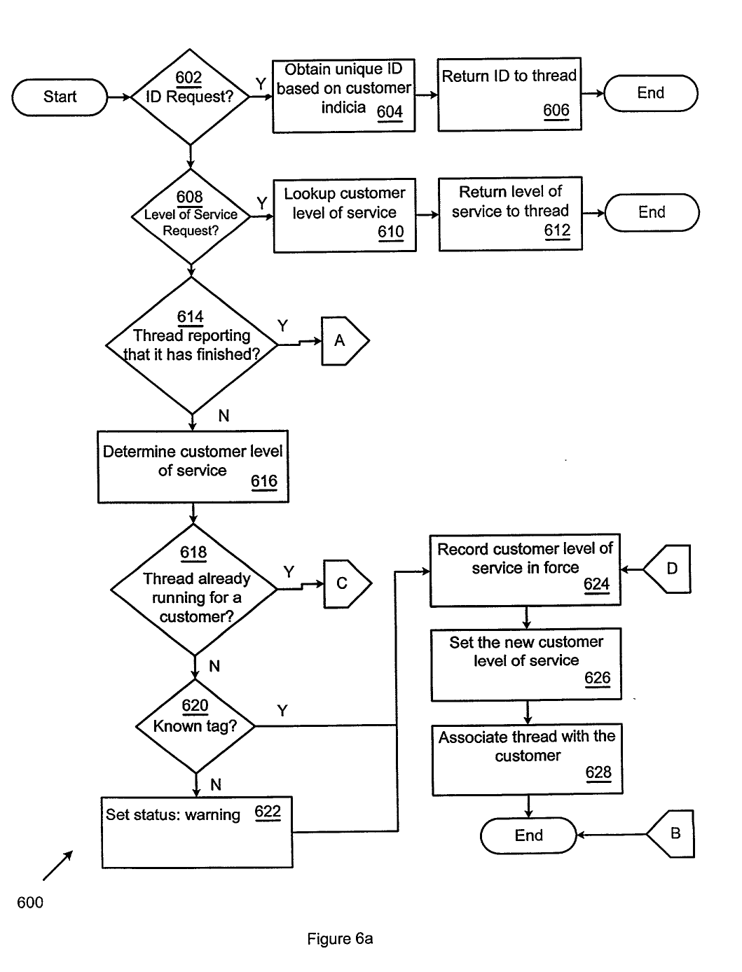

For the purposes of discussion below, it will be assumed that a customer has initiated a database search for a book. A database thread will then handle the search (i.e., the unit of work), and will need CPU resources, disk resources, and I/O resources in order to complete the work. Turning next to FIG. 5, that figure shows a flow diagram 500 of the steps that the thread may take in performing the work.

Initially, the thread receives a request to perform the data base search work (step 502). Because the thread may have already done work for a customer and already know the customer identifier, the thread first checks to see whether the customer is already identified (step 504). If not, the thread determines whether customer indicia (e.g., a user name and password, a credit card number, or the like) are available from any programs interacting with the customer, for example, a web server program (step 506).

If customer indicia are available, the thread provides the indicia to the priority control program 116 and obtains in return a non-anonymous customer identifier (step 508). Otherwise, the thread obtains an anonymous customer identifier (step 510) from the priority control program.

The anonymous customer identifier is generally used as a placeholder identifier until a specific non-anonymous customer identifier can be determined. The anonymous customer identifier allow the priority control program 116 to track resource usage to the temporary customer identifier until such time as sufficient customer indicia are available to replace the anonymous customer identifier with a non-anonymous customer identifier. As a result, for example, a customer who (before logging in or otherwise identifying himself) casually browses a web site, searches for books, places them in a shopping cart, views tables of contents, and the like be assigned an anonymous customer identifier for resource use tracking purposes. When the customer, for example, purchases items in the shopping cart and provides identifying indicia, the threads subsequently working for the customer can obtain a non-anonymous customer identifier. As noted below, the threads may then inform the priority control program 116 that the previously anonymous customer identifier should be replaced by the newly obtained non-anonymous customer identifier.

Given the customer identifier, the thread may optionally request the associated customer level of service from the priority control program 116 (step 512). As a result, the thread may update the customer identifier and customer level of service in the customer tag (step 514). Thus, when the thread provides the customer tag to the priority control program 11, the priority control program 116 need not look up the customer level of service. Instead the priority control program 116 may retrieve the customer level of service from the customer tag.

The priority control program 116 locates the customer identifier in the customer level of service table 122, and obtains the assigned customer level of service. The priority control program 116 then returns the customer level of service to the thread. Note that the customer level of service table 122 may not have an entry for every customer. For example, a new customer generally will not be present in the customer level of service table 122. As a result, the priority control program 116 may instead assign a default customer level of service to the new customer, add the customer to the customer level of service table 122 (at the default level), and return the default level of service to the thread.

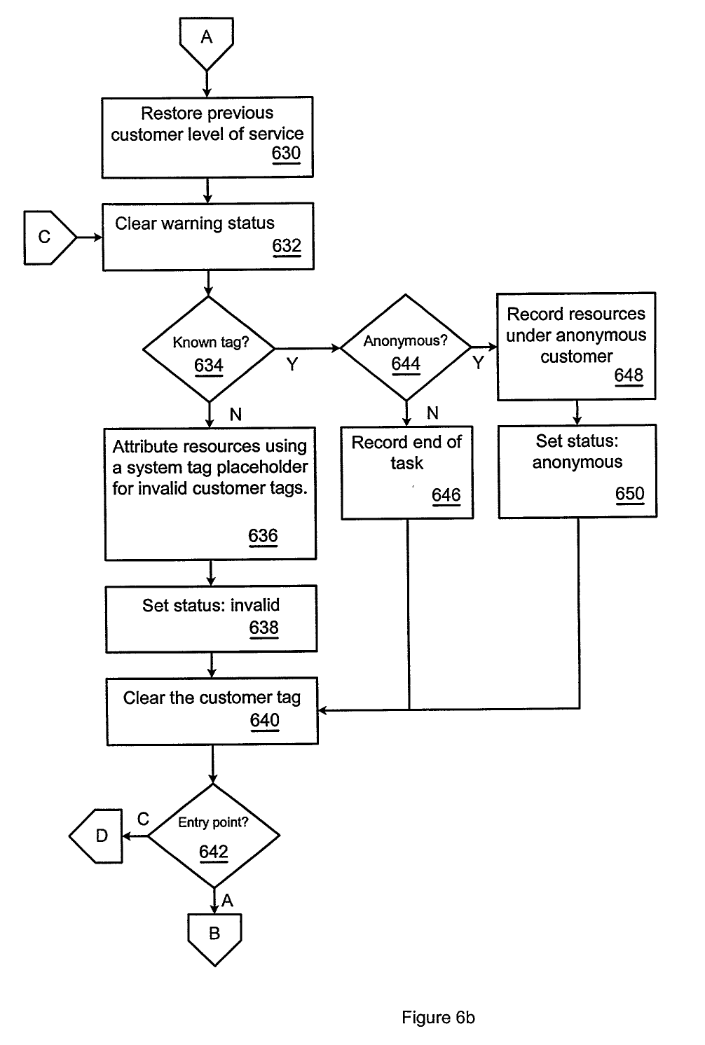

Next, the thread retrieves the customer tag (step 516). The thread then sends a message to the priority control program 116 with the customer tag (step 518). As a result, the priority control program 116 will set resource priority levels in accordance with the customer level of service (as described in more detail below with respect to FIG. 6). Note also that the thread may save system communication resources by not explicitly informing the priority control program 116 that the thread has finished working for a particular customer. If the priority control program 116 receives a customer tag that specifies a customer other than the one currently being serviced, then the priority control program 116 implicitly understands that work for the previous customer has finished. The priority control program 116 may then update the resource tracking statistics for the previous customer (as well as initiate tracking for the new customer) as described in more detail below.

Optionally, the thread next obtains a work description for the work to be performed for the customer (step 520). The work description is provided by a program interacting with the customer (e.g., the web server) and indicates what work needs to be performed. For example, the work description may specify a data base search for a particular book. The work description may also include customer indicia, if they have become available. Thus, for example, the work description may indicate a database search for a customer name.

The thread checks to determine if the work description includes customer indicia, and the customer is currently anonymous (step 522). If so, the thread sends a message to the priority control program 116 with the indicia and obtains in return a non-anonymous customer identifier (step 524).

The thread then performs the work for the customer (step 526). For example, the thread may execute instructions that initiate a database search. Note that the work will proceed at the customer level of service specified by the customer level of service table 122 for the customer. Because the priority control program 116 has set resource priorities for the customer, the operating system 118 allocates and provides resources to the thread accordingly. For example, when the priority control program 116 sets a relatively high priority for CPU time, the operating system 118 responsively schedules more thread instructions for execution over a given period of time. Similarly, when, for example, the priority control program 116 sets a relatively high priority for disk I/O, the operating system 118 responsively schedules a greater percentage of disk access time for the thread.

After the thread performs the work, the thread checks to determine whether the thread has additional work waiting for the same or different customer (e.g., by checking a queue of work description entries for the thread) (step 528). If more work is waiting, the thread proceeds to step 504 where the thread again determines if the work is being done for an already-identified customer.

However, if no additional work is waiting, then the thread informs the priority control program 116 that the thread has finished working for the customer. (step 530). The thread then terminates. Alternatively, the thread may persist, and simply wait for additional work to arrive. When additional work is available, the thread proceeds to step 504.

Note that the priority control program 116 optionally tracks resource usage by the customer (e.g., number of milliseconds of disk I/O and CPU time, number of I/O requests, bytes of data read or written, and the like) while the thread is working for the customer. When the thread informs the priority control program 116 that the thread has finished working for the customer, the priority control program 116 may then write a record of the resource usage attributable to the customer into memory for future analysis and accounting. Note that, even when a customer cannot be immediately identified, the priority control program 116 may still track resource usage using the anonymous customer identifier

When the priority control program 116 receives a message from a thread concerning work being performed on behalf of a customer, the priority control program 116 responds as shown in FIGS. 6a-6b. In particular, FIG. 6 shows a flow diagram 600 of the steps that the priority control program 116 may take when it receives a message (typically including a customer tag) to the effect that a thread is finished working for a customer or is starting work for a customer.

Initially, the priority control program 116 determines whether the message is a request for a customer identifier (step 602). If so, the priority control program 116 obtains a unique customer identifier using, for example, customer indicia (such as a username and password) present in the message from the thread (step 604). The priority control program 116 may use the UID interface explained above to generate a unique customer identifier. Generally, the priority control program 116 also stores the new customer identifier in the customer level of service table 122, along with an initial default level of service. Note that the message may indicate that the thread is unaware of a specific identity for the customer. In that case, the priority control program 116 may obtain a unique customer identifier for an anonymous customer instead. The priority control program 116 then returns the customer identifier to the thread (step 606).

The priority control program 116 further determines whether the message received from the thread includes a request for the level of service associated with a customer (step 608). If the thread requests the level of service, then the priority control program 116 obtains the customer level of service (e.g., from the customer level of service table 122) using, for example, the customer identifier provided in the customer tag (step 610). The priority control program 116 then returns the customer level of service to the thread (step 612).

If the message does not include one of the two types of requests noted above, then the message generally indicates instead that the thread is finishing or beginning work for a customer. The priority control program 116 responds as described below.

The priority control program 116 determines whether the message sent informs the priority control program 116 that the thread has finished working for the customer (step 614). If so, the priority control program 116 branches to A (shown in FIG. 6b) to perform record keeping activities. Otherwise, the priority control program 116 determines a customer level of service for the new customer (step 616). Note that if the customer cannot be specifically identified (e.g., using the customer identifier in the customer tag and the customer level of service table 122), then the priority control program 116 may use a customer level of service appropriate for an anonymous customer, or other type of unidentified customer.

If the thread was already running on behalf of another customer, then the priority control program 116 branches to C to perform record keeping activities (step 618). In other words, when the thread was already running on behalf of a first customer, and informs the priority control program 116 that the thread is going to work for a second customer, then the thread has implicitly informed the priority control program 116 that the thread has finished work for the first customer. Thus record keeping activities for the first customer are appropriate.

If the thread was not already running on behalf of a customer, then the priority control program 116 determines whether the customer tag (and in particular the customer identifier) represents a known customer (step 620). If not, then the priority control program 116 sets and returns to the thread a warning (step 622) and branches to step 624. The customer is a known customer when the customer (including anonymous customers) has an entry in the customer level of service table 122.

Continuing at step 624, the priority control program records the current customer level of service in force (if any). The priority control program 116 then sets the new customer level of service (step 626). As noted above, the priority control program 116 sets the new customer level of service by retrieving resource priorities from the task-priority table 124 and communicating the resource priorities to the operating system 118, for example, in a message. The operating system 118 enforces the resource priorities though scheduling, queueing, and the like subsequently performed by the operating system 118 for thread instructions, I/O requests, and other resources.

The priority control program 116 then associates the thread with the customer (step 628). In other words, the priority control program 116 records that the particular thread (e.g., as identified by a process identifier) is performing work for the identified customer. The association between threads and customers may be included in the record keeping activities discussed below.

Turning to FIG. 6b, the record keeping steps for thread activities are illustrated.

When the thread has informed the priority control program 116 that the thread is finished working for a customer, the priority control program 116 follows branch A. As illustrated, the priority control program restores the previous level of customer service, if any (step 630). In other words, the priority control program 116 sets the resource priorities back to their level prior to the work being performed by the current customer. Thus, in cases where a thread was interrupted in its performance of work for a customer, those resource priorities are restored, and the thread may continue to perform work for that customer.

At step 632 (which is also the entry point C from FIG. 6a), the priority control program 116 clears any warning statuses in preparation for subsequent warning determinations noted below.

The priority control program 116 then determines whether the customer tag is a known tag (step 634). If the tag is unknown, then the priority control program 116 attributes the resources used by the customer to a reserved system tag placeholder (step 636). The priority control program 116 also sets a warning for the thread that the customer tag was invalid (step 638). The priority control program 116 also clears the customer tag (step 640) now that the work has finished for this customer. Depending on the entry point, the process branches to point B or to point D in FIG. 6a (step 642).

Note that if the customer tag is a known customer tag, then the priority control program 116 determines whether the customer tag is anonymous (step 644). If the customer tag is not anonymous, then the priority control program 116 records that the thread has finished working for the specific customer (step 646). Otherwise, the priority control program 116 records the resources used under the anonymous customer identifier (step 648), and sets a warning flag to inform the thread that the customer is anonymous (step 650).

As noted above, a thread may subsequently inform the priority control program 116 of the identity of a specific customer for which work was done anonymously, when the thread later learns of the customer identity. The priority control program 116 may then change the resource records to attribute resource usage by the anonymous customer identifier to the specific customer.

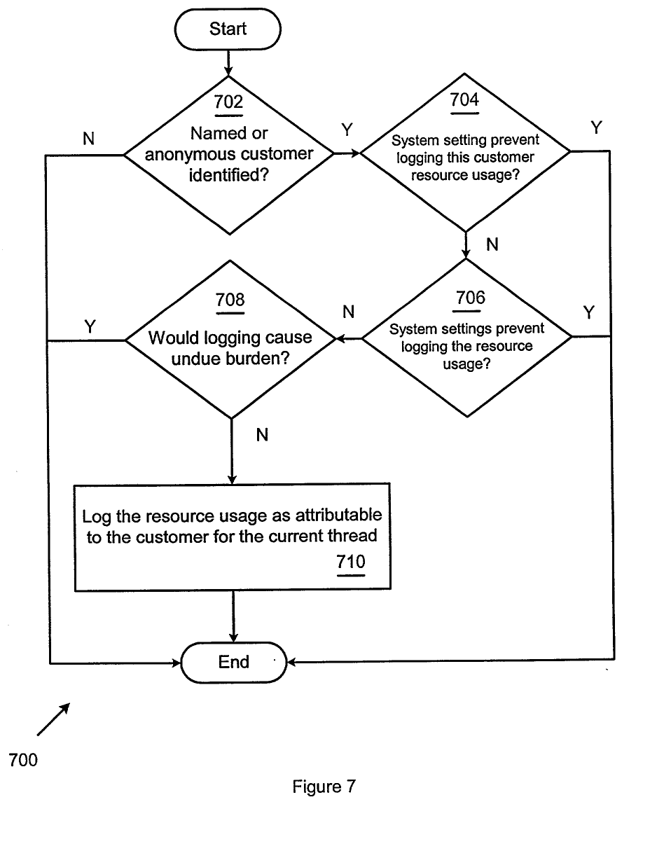

Note that the priority control program 116 need not track all resource usage, or any resource usage. To that end and turning to FIG. 7, a flow diagram 700 is presented that depicts a process for determine when to track resource usage. Thus, the priority control program 116 may skip resource tracking, for example, when the priority control program 116 was not able to ascertain a specific or anonymous customer (step 702) or when system settings dictate not to track resources for a customer (step 704). As additional examples, the priority control program 116 may skip tracking of selected resources when system settings dictate (step 706), or when tracking the resources would create an undue burden on the system (step 708). Otherwise, the priority control program 116 logs the resource usage as attributable to the customer (step 710).

Note that the priority control program 116 may track the use of many different types of resources. As an example, the priority control program 116 may track the amount or percentage of time allocated to a thread for executing thread instructions. As another example, the priority control program 116 may track the number of bytes transferred by a thread through a particular I/O device (e.g., a disk drive, network connection, serial port, parallel port, or the like.

Thus, methods, systems, and articles of manufacture consistent with the present invention facilitate resource priority control tailored to individual customers. As a result, customers receive the level of service that they have paid for, have earned, or have been granted. The resource priority control techniques also provide observability on a customer level. In other words, data processing systems are able to track and record the use of system resources on a per-customer basis, and thus additionally provide customer based accounting, billing, and analysis functionality.

The foregoing description of an implementation of the invention has been presented for purposes of illustration and description. It is not exhaustive and does not limit the invention to the precise form disclosed. Modifications and variations are possible in light of the above teachings or may be acquired from practicing of the invention. For example, the described implementation includes software but the present invention may be implemented as a combination of hardware and software or in hardware alone. Note also that the implementation may vary between systems. For example, in one system, threads may be modified to send messages to a priority control program in the operating system to effect the resource priority control. In other implementations, however, the operating system may automatically detect the initiation of work by threads, obtain a customer identifier, and responsively set the resource priorities. In still other implementations, each thread may incorporate a priority control program to manage resource priorities for multiple customers. The invention may be implemented with both object-oriented and non-object-oriented programming systems. The claims and their equivalents define the scope of the invention.

What is claimed is:

1. A method in a data processing system for customer resource priority control, the method comprising the steps of:
receiving a request by a program to perform work on behalf of a customer, the request including a customer identifier;
sending the customer identifier to a priority control program in the data processing system;
identifying by the priority control program a priority level associated with the customer;
running the program by the data processing system at the priority level such that the work is performed on behalf of the customer at the associated priority level of the customer.

2. The method according to claim 1, further comprising the steps of:
informing the priority control program that the program has finished the work.

3. The method according to claim 2, further comprising the step of
restoring a prior priority level.

4. The method according to claim 1, further comprising the step of setting a task-resource priority based on the priority level.

5. The method according to claim 1, further comprising the step of setting a task-resource priority obtained from a priority table organized by task and resource.

6. The method according to claim 1, wherein the step of running comprises the step of obtaining and using quantities of system resources, and further comprising the step of tracking the quantities as attributable to the customer.

7. The method according to claim 1, further comprising the step of obtaining a customer tag including the unique customer identifier.

8. The method according to claim 1, further comprising the step of obtaining a customer tag including the customer identifier and a customer level of service.

9. The method according to claim 1, further comprising the step of obtaining a customer tag including the customer identifier, a customer level of service, and a data system processing identifier.

10. The method according to claim 9, wherein the data processing system identifier is a network address.

11. The method according to claim 1, wherein the customer identifier is an anonymous customer identifier.

12. The method according to claim 11, further comprising the step of replacing the customer identifier with a non-anonymous customer identifier.

13. A computer-readable medium containing instructions that cause a data processing system to perform a method for resource priority control, the method comprising the steps of:
obtaining a customer identifier representing a customer;
submitting the customer identifier to a priority control program in the data processing system to inform the data processing system that the program will perform work for the customer;
identifying a customer level of service for the customer;
adjusting a resource priority based on the customer level of service; and
running the program by the data processing system in accordance with the resource priority such that the work is performed on behalf of the customer at the associated priority level of the customer.

14. The computer-readable medium according to claim 13, wherein the method further comprises the steps of informing the priority control program that the program has finished the work.

15. The computer-readable medium according to claim 13, wherein the step of adjusting a resource priority comprises setting a task-resource priority based on the customer level of service.

16. The computer-readable medium according to claim 13, wherein the step of adjusting a resource priority comprises setting a task-resource priority obtained from a priority table organized by task and resource.

17. The computer-readable medium according to claim 13, further comprising the steps of obtaining and using quantities of system resources, and tracking the quantities as attributable to the customer.

18. The computer-readable medium according to claim 13, wherein the step of obtaining comprises the step of obtaining an anonymous customer identifier.

19. The computer-readable medium according to claim 18, further comprising the step of replacing the customer identifier with a non-anonymous customer identifier.

20. A data processing system comprising:
a memory comprising a priority control program and a task-resource priority table, the priority control program receiving a customer tag submitted by an application program performing work on behalf of a customer, determining a customer level of service assigned to the customer, and responsively adjusting a resource priority according to the task-resource table such that the work is performed for the customer according to the resource priority and the customer level of service; and
a processor that runs the priority control program.

21. The data processing system according to claim 20, wherein the task-resource priority table comprises a plurality of priorities, individually assigned to tasks and resources.

22. The data processing system according to claim 21, wherein the resources include CPU time.

23. The data processing system according to claim 21, wherein the resources include input/output bandwidth.

24. The data processing system according to claim 23, wherein the input/output bandwidth comprises disk bandwidth.

25. The data processing system according to claim 2 3, wherein the input/output bandwidth comprises network bandwidth.

26. The data processing system according to claim 20, wherein the customer tag is a temporary anonymous customer tag.

27. The data processing system according to claim 20, wherein the customer tag is a non-anonymous customer tag.

28. The data processing system according to claim 20, wherein the customer tag comprises a customer identifier field and a customer level of service field.

29. The data processing system according to claim 28, wherein the customer tag further comprises a data processing system identifier field.

30. The data processing system according to claim 29, wherien the data processing system identifier is a network address.

31. A data processing system comprising:
means for receiving a customer tag and obtaining a customer level of service corresponding to a customer identifier in the customer tag;
means for adjusting task-resource priorities based on the customer level of service; and
means for running a program performing work for the customer according to the task-resource priorities and the customer level of service.

32. A computer-readable memory device encoded with a data structure accessed by a priority control program that is encoded in the computer-readable memory device and that is run by a processor in a data processing system, the data structure comprising entries, each entry associated with a customer and each entry comprising:
a customer identification field that identifies the customer; and
a customer level of service field that identifies a level of service for the customer, wherein the priority control program accesses the data structure to adjust a priority level of a resource on behalf of the customer so that the customer receives the identified level of service.

33. The data structure of claim 32 further comprising a data processing system identifier field.

34. A computer-readable memory device encoded with a data structure accessed by a priority control program run by a processor in a system, the data structure comprising:
a resource index;
a task index; and
a priority entry for each resource-task pair specified by the resource index and the task index; wherein
the priority control program accesses the data structure to adjust resource priority levels on behalf on the customer.

35. A method in a data processing system having a program, the method comprising the steps of:
receiving a plurality of requests by the program, each request to perform processing on behalf of a customer; and
for each request,
determining a level of service associated with the customer; and
performing the processing for the customer at the determined level of service.

36. The method according to claim 35, wherein the step of determining a level of service comprises the step of determining a level of service using a customer level of service table.

37. The method according to claim 35, wherein the step of determining comprises the steps of obtaining a customer identifier and determining the level of service based on the customer identifier.

38. The method according to claim 35, further comprising the step of setting a resource priority specified by the level of service.

39. The method according to claim 35, wherein the step of receiving comprises the step of receiving a customer tag comprising a customer identifier.

40. A computer-readable medium comprising instructions that cause a program in a data processing system to perform a method, the method comprising the steps performed by the program of:
receiving a request to perform first processing on behalf of a first customer;
identifying a first level of service associated with the first customer;
performing the first processing at the first level of service;
receiving a request to perform second processing on behalf of a second customer;
identifying a second level of service associated with the second customer, the second level of service being different than the first level of service; and
performing the second processing at the second level of service.

41. The computer-readable medium according to claim 40, wherein the step of performing the first processing comprises the step of sending a request to a priority control program, the request specifying the first level of service.

42. The computer-readable medium according to claim 40, wherein the step of performing comprises the step of sending a customer tag to a priority control program, the customer tag including a customer identifier and specifying the first level of service.

43. The computer-readable medium according to claim 40, wherein the step of identifying a first level of service comprises the step of submitting customer indicia to a priority control program.

44. The computer-readable medium according to claim 43, wherein the step identifying a first level of service further comprises the step of receiving a message from the priority control program, the message specifying the first level of service.
